(19) United States
(12) Patent Application Publication
(10) Pub. No.: US 2010/0131886 A1
(43) Pub. Date: May 27, 2010

(54) DISPLAY SYSTEM AND METHOD FOR GENERATING ENHANCED SCROLLBAR

(75) Inventors: Aaron Gannon, Anthem, AZ (US); Blake Wilson, Peoria, AZ (US); Roger W. Burgin, Scottsdale, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/323,759

(22) Filed: Nov. 26, 2008

(51) Int. Cl. G06F 3/048; G09G 5/00

(52) U.S. Cl. 715/786; 345/684

(57) ABSTRACT

A display system is provided for displaying a categorized data group divided into multiple data group sections by at least one section break. In one embodiment, the display system includes a monitor, a cursor device; and a controller operably coupled to the monitor and to the cursor device. The controller is configured to generate on the monitor: (i) a viewport displaying a portion of the categorized data group, (ii) a scrollbar adjacent the viewport, and (iii) a cursor graphic positioned in accordance with user input received via the cursor device. The cursor device permits a user to interact with the scrollbar to select which portion of the categorized data group is displayed within the viewport. The scrollbar includes a visual representation of each section break included within the categorized data group.

### TECHNICAL FIELD

The present invention relates generally to graphical user interfaces and, more particularly, to a system (e.g., an aircraft display system) and method for generating an enhanced scrollbar.

### BACKGROUND

In general, a graphical user interface may include a viewport or window (e.g., an area in which data, such as text, is displayed) and at least one virtual widget with which a user may interact to control the interface. Often, a text document or other such data list is too lengthy to be displayed within a viewport while maintaining desired viewing settings (e.g., zoom level). Consequently, only a portion of the data list may displayed within the viewport at a given time and a scrollbar may be generated adjacent the viewport to permit the user to navigate through the data list as desired. A representative scrollbar includes a long rectangular area (referred to herein as an “elevator shaft” and also commonly referred to as a “trough”) containing an elevator (also commonly referred to as a “bar,” “thumb,” “puck,” “wiper,” or “knob”), which may be moved within the elevator shaft. The position of the elevator within the elevator shaft corresponds to the portion of the data list displayed within the viewport; e.g., if the elevator is located at the bottom of a vertically-oriented elevator shaft, the viewport will display the lower portion of the data list. Similarly, the height of the elevator relative to the height of a vertical elevator shaft is generally proportional to the length of the displayed portion relative to the data list's total length; e.g., if the length of the displayed portion is 20% the total length of the data list, the elevator's height will be approximately 20% the height of the elevator shaft.

Utilizing a cursor device, such as a mouse, trackball, touchpad, or keyboard-mounted knob (commonly referred to as a “pointing stick”) a user may interact with the scrollbar to determine which portion of the data list is displayed within the viewport at a given time. For example, and again referring to a vertically-oriented elevator shaft, a user may drag the scrollbar's elevator to a desired location to scroll the displayed data list portion upward or downward. A user may also move the displayed portion of the data list up or down a full screen by selecting (“clicking”) an area of the elevator shaft above or below the elevator, respectively. Finally, if virtual arrow buttons are provided near the top and bottom of the elevator shaft, a user may selected the upper or lower arrow buttons, respectively, to move the displayed portion of the data list upward or downward by a single line.

In certain cases, a data list may include multiple prioritized sections. As a general example, an aircraft display system may convey navigational information to pilot and crew utilizing a data list containing messages of varying criticality. As a more specific example, a Crew Alert System (CAS) display system may be deployed on the flight deck of an aircraft. The CAS display system includes a monitor (e.g., a multi-function display) on which a CAS data list is displayed. The CAS data list contains one or more of the following sections: (i) a “Warning Section” listing critical items that should be addressed immediately by the pilot or crew; (ii) a “Caution Section” listing important alert messages that should be heeded by the pilot and crew, but do not require immediate attention; and (iii) an “Information Section” listing informational items of lesser importance. If the CAS data list is only partially displayed within a viewport, a scrollbar of the type described above is produced adjacent the viewport. The scrollbar provides crewmembers with a relatively intuitive means for navigating through the CAS data list; however, the scrollbar does not provide any indication of the number, the relative length, and the priority of the sections included within the CAS data list. As a result, an aircraft crewmember is generally required to undergo the somewhat cumbersome process of scrolling through the entire CAS data list to determine this information. Notably, in the context of a CAS display system or other such aircraft display system, a crewmember may move the elevator within the elevator shaft by rotating a ruggedized dial mounted near the display system's monitor instead of selecting virtual arrow buttons, the elevator shaft, or other widgets with a cursor graphic.

Considering the above, it is desirable to provide a system (e.g., an aircraft display system) and method for generating an enhanced scrollbar that visually indicates the number, relative length, and priority of multiple sections included within a given data list. It would also be desirable for such an enhanced scrollbar to provide information regarding the content of each of the different data list sections. Finally, it would also be desirable for such an enhanced scrollbar to permit a user to easily center the scrollbar's elevator as desired. Other desirable features and characteristics of the present invention will become apparent from the subsequent Detailed Description and the appended claims, taken in conjunction with the accompanying drawings and this Background.

### BRIEF SUMMARY

A display system is provided for displaying a categorized data group divided into multiple data group sections by at least one section break. In one embodiment, the display system includes a monitor, a cursor device; and a controller operably coupled to the monitor and to the cursor device. The controller is configured to generate on the monitor: (i) a viewport displaying a portion of the categorized data group, (ii) a scrollbar adjacent the viewport, and (iii) a cursor graphic positioned in accordance with user input received via the cursor device. The cursor device permits a user to interact with the scrollbar to select which portion of the categorized data group is displayed within the viewport. The scrollbar includes a visual representation of each section break included within the categorized data group.

A method is also provided for generating an enhanced scrollbar on the monitor of a display system, which displays a portion of a categorized data group containing multiple data group sections each separated by a section break. In one embodiment, the method includes the steps of determining the length of the categorized data group and the location of each section break included within the categorized data group, and generating on the monitor: (i) an elevator shaft; (ii) an elevator within the elevator shaft, and (iii) at least one section break graphic representative of each section break included within the categorized data group. The height of the elevator relative to the height of the elevator shaft generally corresponds to the length of the displayed portion of the categorized data group relative to the categorized data group's total length; and the section break graphic visually divides the elevator shaft into multiple shaft portions each corresponding to, and generally proportional with, a different data group section included within the categorized data group.

A program product is further provided for execution by an aircraft display system including a controller, at least one monitor, and a cursor device. The aircraft display system is configured to display a categorized data group including multiple data group sections each separated by a section break. In one embodiment, the program product includes an avionics display program adapted to generate on the monitor: (i) a viewport displaying a portion of the data list, (ii) a scrollbar adjacent the viewport and including a visual representation of each section break included within the categorized data group, and (iii) a cursor graphic positioned in accordance with user input received via the cursor device. The cursor device permits a user to interact with the scrollbar to select which portion of the categorized data group is displayed within the viewport. The program product further includes computer-readable media bearing the avionics display program.

### BRIEF DESCRIPTION OF THE DRAWINGS

At least one example of the present invention will hereinafter be described in conjunction with the following figures, wherein like numerals denote like elements, and:

FIG. 1 is a functional block diagram of a generalized display system suitable for generating an enhanced scrollbar in accordance with an exemplary embodiment;

FIG. 2 illustrates an exemplary data list including three prioritized data sections list sections that may be generated on a monitor included within the generalized display system shown in FIG. 1;

FIGS. 3 and 4 are screenshots of an exemplary viewport and an exemplary enhanced scrollbar that may be generated by the display system shown in FIG. 1 utilizing the data list shown in FIG. 2;

FIG. 5 is a screenshot of the exemplary viewport and exemplary enhanced scrollbar shown in FIGS. 3 and 4 illustrating one manner in which the enhanced scrollbar may visually indicate the content of a data list section corresponding to a selected elevator shaft portion;

FIG. 6 is a screenshot of the exemplary viewport and exemplary enhanced scrollbar shown in FIGS. 3-5 illustrating one manner in which a user may center the scrollbar elevator at a desired location; and

FIG. 7 is a flowchart illustrating an exemplary process that may be carried out by the display system shown in FIG. 1 to generate a visual representation of the data list shown in FIG. 2 and the enhanced scrollbar shown in FIGS. 3-6.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

FIG. 1 is a functional block diagram of a generalized display system 20. Display system 20 includes at least one monitor 22, a controller 24, a plurality of data sources 26, and a cursor device 28, such as a trackball, mouse, touchpad, or keyboard-mounted knob (commonly referred to as a “pointing stick”). In embodiments wherein display system 20 assumes the form of an aircraft display system, cursor device 28 may also comprise (e.g., in addition to a trackball) a ruggedized concentric knob or dial mounted within the aircraft cockpit proximate monitor 22. Controller 24 has at least first and second inputs, which are operatively coupled to data sources 26 and to cursor device 28, respectively; and at least one output, which is operatively coupled to monitor 22. Monitor 22 may comprise any suitable image-generating device including various analog devices (e.g., cathode ray tube) and digital devices (e.g., liquid crystal, active matrix, plasma, etc.). Controller 24 may comprise, or be associated with, any suitable number of individual microprocessors, memories, power supplies, storage devices, interface cards, and other standard components known in the art. In this respect, the controller 24 may include or cooperate with any number of software programs or instructions designed to carry out the various methods, process tasks, calculations, and control/display functions described below.

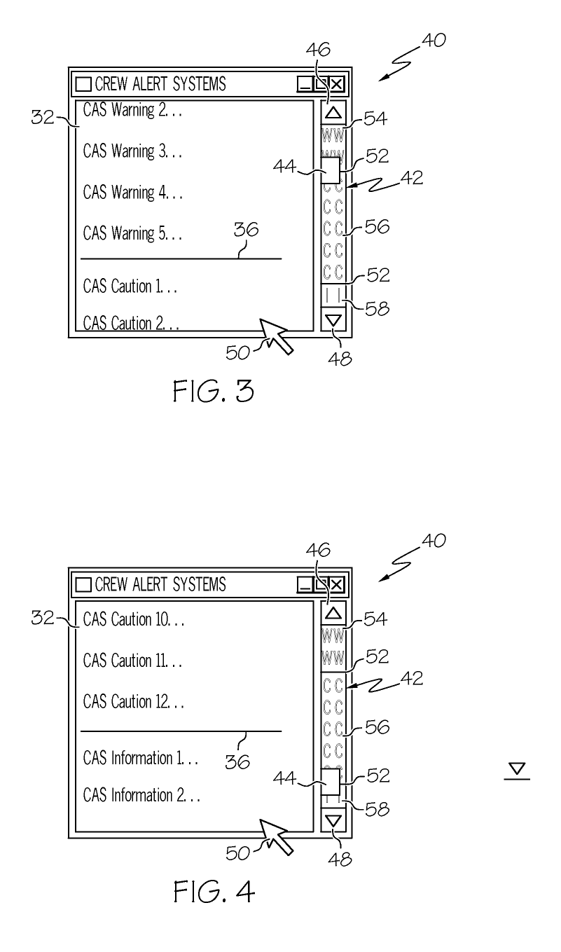

During operation of display system 20, controller 24 drives monitor 22 to produce a visual display 30 thereon. Display 30 includes a viewport 32 in which a portion of a categorized data group is displayed. As described below, the categorized data group may be a graphic, such as a geographical map. However, in a preferred group of embodiments, the categorized data group assumes the form of a data list, such as a text document. In such embodiments, the data list may be compiled from data provided by data sources 26 and/or data stored within a memory associated with controller 24. When the data list is too lengthy to be displayed entirely within viewport 32, controller 24 generates a portion of the data list within viewport 32. In such cases, controller 24 further generates an enhanced scrollbar adjacent viewport 32 (not shown in FIG. 1). Utilizing cursor device 28, a user may interact with the enhanced scrollbar to manipulate the portion of the data list displayed within viewport 32. An exemplary embodiment of an enhanced scrollbar that may be generated by controller 24 on monitor 22 is described below in conjunction with FIGS. 3-6.

In one group of embodiments, display system 20 may be deployed on the flight deck of an aircraft. In such embodiments, monitor 22 may assume the form a Multi-Function Display (MFD) included within a Crew Alert System (CAS), such as an Engine Instrument and Crew Advisory System (EICAS). Similarly, controller 24 may assume the form of, for example, a Flight Management Computer of the type commonly deployed within a Flight Management System (FMS); and data sources 26 may include one or more of the following systems: various operational sensors onboard the aircraft, a runaway awareness and advisory system, an instrument landing system, a flight director system, a weather data system, a terrain avoidance and caution system, a traffic and collision avoidance system, a terrain database, an inertial reference system, and a navigational database.

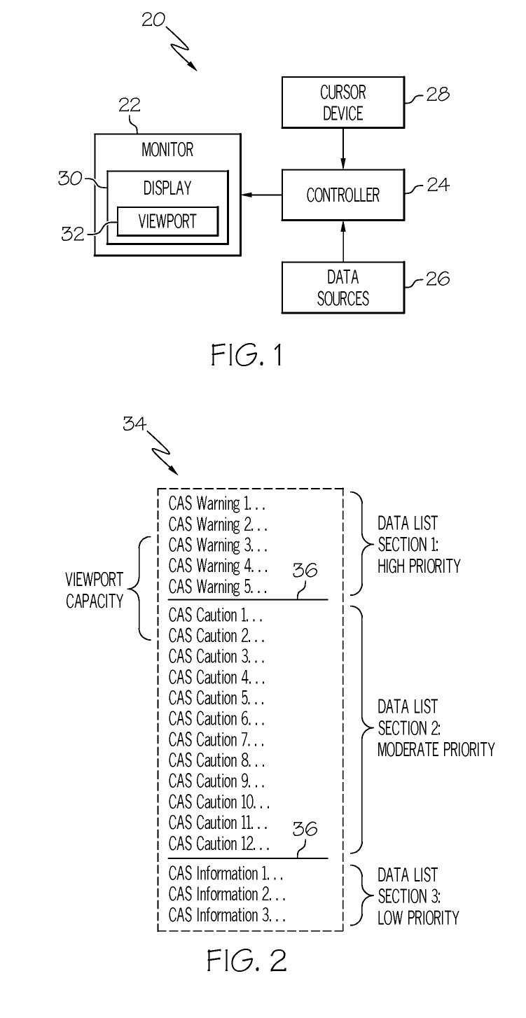

FIG. 2 illustrates an exemplary data list 34 that may be generated, in part, on monitor 22 by controller 24 (FIG. 1). In this particular example, data list 34 assumes the form of a CAS data list divided into three data list sections; i.e., (i) a Warning Section, (ii) a Caution Section, and (iii) and Information Section. As indicated in FIG. 2, the Warning Section includes five separate warning messages, the Caution Section includes twelve separate alert messages, and the Information Section includes three separate informational items. The warning messages contained within the Warning Section are labeled generically in FIG. 2 as “CAS Warning 1,” “CAS Warning 2,” “CAS Warning 3,” and so on. The caution messages contained within the Caution Section and the informational items contained within the Information Section are also generically labeled in a similar manner. The different sections of data list 34 are separated by section breaks 36, which are represented in FIG. 2 by first and second solid lines. As used herein, the term “section break” is defined broadly to encompass a location at which one category of data (e.g., a first data list section) generally ends and a second category of data (e.g., a subsequent data list section) generally begins. The section breaks may not be visible within the viewport in alternative embodiments.

With continued reference to FIG. 2, the different data list sections included within data list 34 are prioritized. More specifically, the Warning Section is considered high priority and contains critical warning messages that should be immediately addressed by the pilot or crew; the Caution Section is considered moderate priority and contains alert message that should be heeded by the pilot and crew, but do not require immediate attention; and the Information Section is considered low priority and contains miscellaneous informational items. “FAILURE #2 ENGINE” is an example of a high priority warning that might be included within the Warning Section, “ONE HOUR FUEL REMAINING” is an example of a moderate priority caution that might be included within the Caution Section, and “DATABASE UPDATE DUE IN 3 DAYS” is an example of a low priority informational message that might be included within the Information Section.

Depending upon viewing settings (e.g., the selected zoom level), viewport 32 (FIG. 1) may only be capable of displaying a portion of data list 34 at a given time. For example, and as indicated in FIG. 2 by the bracket labeled “VIEWPORT CAPACITY,” viewport 32 may be able to display approximately 25% of data list 34 at a given time. Therefore, to permit a user to navigate through data list 34 with the aid of cursor device 28, controller 24 further generates an enhanced scrollbar adjacent viewport 32. The scrollbar generated by controller 24 is considered “enhanced” in that it indicates the number and relative length of sections included within data list 34. In certain embodiments, the enhanced scrollbar may also indicate the priority of the different data list sections and, perhaps, the content thereof. In further embodiments, the scrollbar may also permit the user to easily center the scrollbar's elevator at a desired location. An example of such an enhanced scrollbar will now be described in conjunction with FIGS. 3-6.

FIGS. 3 and 4 are screenshots of viewport 32 and an exemplary enhanced scrollbar 40 that may be generated on monitor 22 by controller 24 (FIG. 1). In keeping with the example introduced above, controller 24 may generate a portion of CAS data list 34 (FIG. 2) within viewport 32. In the exemplary embodiment shown in FIGS. 3 and 4, scrollbar 40 includes: (i) a vertically-oriented elevator shaft 42, (ii) a elevator 44 within elevator shaft 42, and (iii) first and second virtual arrow buttons 46 and 48 positioned near the top and bottom of elevator shaft 42, respectively. The position of elevator 44 within elevator shaft 42 generally corresponds to the portion of data list 34 (FIG. 2) displayed within viewport 32. Similarly, the height of elevator 44 relative to the height of a vertical elevator shaft 42 is generally proportional to the length of the displayed portion of data list 34 relative to total length of data list 34.

A cursor graphic 50 is also generated on the display and positioned in accordance with user input received via cursor device 28 (FIG. 1). Utilizing cursor device 28 and cursor graphic 50, a user may adjust the position of elevator 44 within elevator shaft 42 to specify which portion of data list 34 (FIG. 2) is displayed within viewport 32 at a given time. For example, a user may adjust the position of elevator 44 by: (i) dragging elevator 44 to a desired location within elevator shaft 42 to scroll the displayed portion of data list 34 upward or downward; (ii) selecting (“clicking”) an area of elevator shaft 42 directly above or below elevator 44 to move the displayed portion of data list 34 upward or downward, respectively, a full screen (indicate in FIG. 4 by re-positioned cursor graphic 50); and/or (iii) selecting upper virtual arrow button 46 or lower virtual arrow button 48 to move the displayed portion of data list 34 upward or downward, respectively, by a single line. In addition, and in contrast to conventional graphic user interface (GUI) scrollbars, a user may also center elevator 44 at a desired location by selecting (“clicking”) a chosen portion of elevator shaft 42 outside of the path of travel of elevator 44 as described more fully below in conjunction with FIG. 6.

The foregoing example notwithstanding, enhanced scrollbar 40 may assume other visual forms and have different functionalities in alternative embodiments. When display system 20 assumes the form of an aircraft display system, such as a CAS display system, enhanced scrollbar 40 may not include virtual arrow buttons 46 and 48. Furthermore, a crewmember may not move elevator 44 within elevator shaft 42 by selecting arrow buttons 46 and 48, by selecting an area of elevator shaft 42 directly above or below elevator 44, or by dragging elevator 44 to a desired location utilizing cursor graphic 50 in the manner described above. Instead, a crewmember may move elevator 44 within elevator shaft 42 by rotating a ruggedized knob or dial (or other such user input) included within cursor device 28. In this case, the dial may be selectively activated by aircraft display system 20 when appropriate; e.g., when a window containing enhanced scrollbar 40 is selected by a crewmember utilizing cursor device 28. To visually indicate that the dial is activated and may now be utilized to move elevator 44 within elevator shaft 42, aircraft display system 20 may generate a graphic (e.g., a scroll icon resembling a curly-cue) on monitor 22 proximate scrollbar 40.

It will be appreciated that certain graphical elements included within scrollbar 40 (e.g., elevator 44 and virtual arrow buttons 46 and 48) are similar to those included within conventional GUI scrollbars. However, as compared to elevator shafts commonly included within conventional GUI scrollbars, elevator shaft 42 includes several unique features. For example, elevator shaft 42 includes a visual representation of each section break 36 included within data list 34. In the illustrated exemplary embodiment, the section breaks 36 are visually indicated by line break graphics 52; e.g., solid lines generally transecting elevator shaft 42. Line break graphics 52 visually divide elevator shaft 42 into three shaft segments 54, 56, and 58, which correspond to the Warning Section, the Caution Section, and the Information Section of data list 34 (FIG. 2), respectively. By visually dividing elevator shaft 42 into shaft segments corresponding to the various sections included within data list 34 (FIG. 2), line break graphics 72 quickly provide the viewer (e.g., aircraft crewmember) with an intuitive indication of the number of sections included within the data list. In addition, line break graphics 72 are distributed along elevator shaft 42 at positions corresponding to the relative positions of section breaks 36 included within data list 34 (FIG. 2). As a result, the relative lengths of shaft segments 54, 56, and 58 are generally proportional with the relative lengths of the Warning Section, the Caution Section, and the Information Section included within data list 34 (FIG. 2). Thus, a viewer glancing at elevator shaft 42 may quickly ascertain that the Warning Section is of moderate length (and, therefore, likely contains a moderate number of warning messages), that the Caution Section is relatively lengthy (and, therefore, likely contains a relatively high number of alert messages), and that the Information Section is relatively short (and, therefore, likely contains relatively few informational items).

Enhanced scrollbar 40 may further provide a visual indication of the relative priority of the different sections included within data list 34 (FIG. 2). In a preferred embodiment, scrollbar 40 visually indicates the priority of the different sections of data list 34 (FIG. 2) by color coding elevator shaft segments 54, 56, and 58 shown in FIGS. 3 and 4. For example, shaft segment 54 may be partially or fully filled with a first color (e.g., red) to indicate that the data list section to which segment 54 corresponds (i.e., the Warning Section) is of high priority; shaft segment 56 may be partially or fully filled with a second color (e.g., yellow) to indicate that the data list section to which segment 56 corresponds (i.e., the Caution Section) is of moderate priority; and shaft segment 58 may be partially or fully filled with a third color (e.g., blue or white) to indicate that the data list section to which segment 56 corresponds (i.e., the Information Section) is of low priority. Of course, visual means other than color coding may also be utilized to indicate the relative priority of the data list sections; e.g., a first symbology or graphical patterning (e.g., cross-hatching) may be generated within shaft segment 54 to indicate that the Warning Section is of high priority status, a second symbology or graphical patterning may be generate within shaft segment 56 to indicated that the Caution Section is of moderate priority status, etc. Alternatively or additionally, visual effects (e.g., flashing graphics, reverse video, etc.) may be utilized to indicate priority of the shaft segments and the data list sections corresponding thereto. Although the data list segments are presented in order of descending criticality in the illustrated exemplary embodiment, this need not always be the case.

Preferably, enhanced scrollbar 40 further provides a visual representation of the type of data contained within each data section of data list 34 (FIG. 2). This visual representation may be continually displayed within scrollbar 40. In FIGS. 3 and 4, for example, shaft segment 54 is patterned with a repeating character (i.e., the letter “W”) representative of the type of data contained within the data list corresponding to shaft segment 54 (i.e., warnings contained within the Warning Section). Similarly, shaft segments 56 and 58 are also pattered with repeating characters (i.e., the letters “C” and “I”) representative of the type of data contained within their corresponding data list sections (i.e., the cautions contained within the Caution Section and informational items contained within the Information Section, respectively). Providing both color coding and graphical pattering of shaft segments 54, 56, and 58 in this manner increases the speed and accuracy with which a viewer (e.g., an aircraft crewmember) is able to comprehend the relative priority of different sections included within data list 34 (FIG. 2).

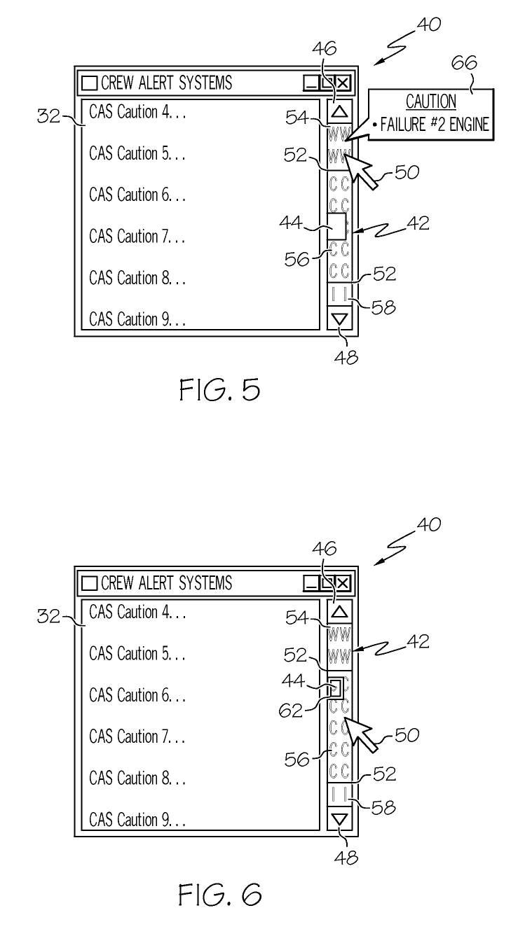

Enhanced scrollbar 40 may also be configured to indicate the content of a particular section of data list 34 (FIG. 2) when a user selects a segment of elevator shaft 42 corresponding to a particular data list section. Further emphasizing this point, FIG. 5 is a screenshot illustrating enhanced scrollbar 40 after a user has utilized cursor device 28 (FIG. 1) to “hover” cursor graphic 50 (i.e., allow cursor graphic 50 to remain substantially motionless) over a particular shaft segment (e.g., segment 54) for a predetermined time period (e.g., 2-3 seconds). In response, controller 24 (FIG. 1) has generated a text box 60 proximate the selected shaft segment (i.e., segment 54). Text box 60 indicates the type of data (i.e., warning messages) contained within the data list section corresponding to the selected shaft segment (i.e., the Warning Section corresponding to shaft segment 54). Text box 60 may also briefly summarize the content of one or more of the messages contained within the Warning Section (e.g., via a text message, such as “Failure #2 Engine”). Similar text boxes may also be generated for the Caution Section and the Information Section if a user utilizes cursor device 28 to hover cursor graphic 50 over shaft segment 56 or shaft segment 58, respectively, in a similar manner.

In addition to providing an intuitive visual indication of the number, relative length, and priority of multiple data list sections, enhanced scrollbar 40 also permits a user to quickly center elevator 44 at a desired location within elevator shaft 42. Referring now to FIG. 6 in conjunction with FIGS. 3-5, it will be noted that the width of elevator shaft 42 is greater than the width of elevator 44. Elevator 44 is positioned to one side of elevator shaft 42 (i.e., the left side shown in example shown in FIGS. 3-6) thus leaving a vertical portion of elevator shaft 42 outside of the elevator's path of travel. As noted above, a user may select (“click”) an area of elevator shaft 42 directly above or below elevator 44 (i.e., within the elevator's path of travel) to move the displayed portion of data list 34 upward or downward, respectively, a full screen. However, if the user instead selects (“clicks”) an area of elevator shaft 42 outside of the elevator's path of travel (i.e., to the right of elevator 44 in the example shown in FIGS. 3-6), controller 24 (FIG. 1) will re-position elevator 44 to be centered with respect to the selected area of elevator shaft 42. Thus, in FIG. 6, a user has utilized cursor device 28 (FIG. 1) to select an intermediate portion of shaft segment 56, and controller 24 has centered elevator 44 with respect to the selected portion of segment 56. In addition, controller 24 has altered the portion of data list 34 displayed within viewport 32 accordingly.

In certain embodiments, controller 24 (FIG. 1) may be configured to render at elevator 44, or at least a portion of elevator 44, semi-transparent. In this manner, elevator shaft 42, and any graphic patterning or line break graphics contained therein, will remain visible even when covered by elevator 44. Alternatively, one or more windows may be provided through elevator 44 as indicated in FIG. 6 at 62.

The foregoing has thus described an exemplary embodiment of display system configured to produce an enhanced scrollbar that visually indicates the number, relative length, and priority of multiple sections included within a data list. In the foregoing exemplary embodiment, the enhanced scrollbar also permitted a user to easily center the scrollbar's elevator at a desired position. While the above-described exemplary embodiment generated an enhanced scrollbar including a vertically-oriented elevator shaft, alternative embodiments of the enhanced scrollbar may instead include a horizontally-oriented elevator shaft. Furthermore, while the above-described exemplary embodiment was generally described in the context of a Crew Alert System (CAS), it should be appreciated that other types of display systems, both avionic and non-avionic, may also be configured to generate the enhanced scrollbar. For example, in a second embodiment, the display system may be deployed on an aircraft and configured to superimpose the enhanced scrollbar over a moving map display. In this case, the enhanced scrollbar may be generated adjacent a viewport displaying a data list including: (i) high priority missed approach instructions, (ii) low priority remarks, and/or (iii) frequencies relative to the aircraft's approach. In a third embodiment, the display system may be deployed on an aircraft and configured to generate the enhanced scrollbar adjacent a viewport displaying a data list including prioritized text messages contained within a weather briefing.

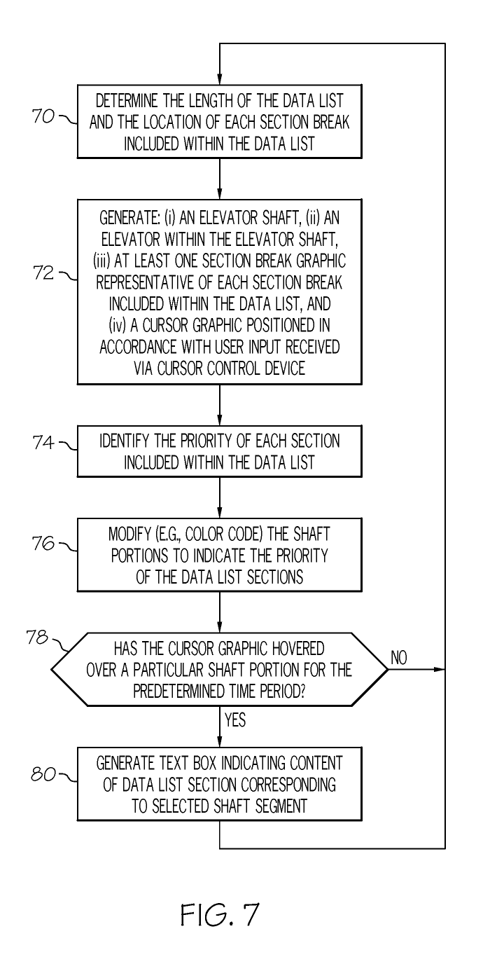

While an exemplary embodiment of the present invention has been described above in the context of a fully functioning computer system (i.e., display system 20 shown in FIG. 1), those skilled in the art will recognize that the mechanisms of the present invention are capable of being distributed as a program product (e.g., an avionics display program) and, furthermore, that the teachings of the present invention apply to the program product regardless of the particular type of computer-readable media (e.g., floppy disc, hard drive, memory card, optical disc, etc.) employed to carry-out its distribution. Similarly, embodiments of the present invention may be implemented as a method. To further emphasize this point, an exemplary method for generating enhanced scrollbar 40 (FIGS. 3-6) will now be described in conjunction with FIG. 7.

FIG. 7 is a flow chart illustrating an exemplary method that may be carried out by controller 24 (FIG. 1) to generate enhanced scrollbar 40 (FIGS. 3-6) on monitor 22 (FIG. 1). To commence (STEP 70), controller 24 determines the length of the data list to be displayed on monitor 22 (e.g., data list 34 shown in FIG. 2), as well as the location of each section break included within the data list. Next (STEP 72), controller 24 generates the following visual elements on monitor 22: (i) an elevator shaft (e.g., elevator shaft 42 shown in FIGS. 3-6), (ii) an elevator within the elevator shaft (e.g., elevator 44 shown in FIGS. 3-6), (iii) at least one section break graphic representative of each section included within the data list (e.g., section break graphics 52 shown in FIGS. 3-6), and (iv) a cursor graphic positioned in accordance with user input received via cursor device 28 (e.g., cursor graphic 50 shown in FIGS. 3-6). As noted above, the section break graphics visually divide the elevator shaft into multiple shaft segments (e.g., shaft segments 54, 56, and 58 shown in FIGS. 3-6) each corresponding to a different data list section included within the data list. After performing STEP 72, controller 24 next identifies the priority of each section included within the data list (STEP 74) and subsequently modifies the appearance of the shaft portions to indicate the priority of each data list section associated therewith (STEP 76). For example, and as discussed above in conjunction with FIGS. 3 and 4, controller 24 may color code each of the shaft portions in accordance with the priority of the data list sections corresponding thereto; e.g., the shaft portion or portions corresponding to high priority data list sections may be color coded red. At STEP 78, controller 24 determines if the cursor graphic (e.g., cursor graphic 50 shown in FIGS. 3-6) has hovered over a particular shaft portion for a predetermined time period (e.g., 2-3 seconds). If the cursor graphic has not hovered over a particular shaft portion for the predetermined time period, controller 24 returns to STEP 70 and the process is repeated. If, instead, the cursor graphic has hovered over a particular shaft portion for a predetermined time period, controller 24 generates a text box (e.g., text box 66 shown in FIG. 5) proximate the scrollbar indicating the content of the data list section corresponding to selected shaft portion (STEP 80). Controller 24 then returns to STEP 70, and the process is repeated. The exemplary process illustrated in FIG. 7 may be continually repeated at a desired refresh rate to update the scrollbar to reflect changes that may occur to the data list (e.g., the addition or deletion of warnings, cautions, or informational items from data list 34 shown in FIG. 2).

As noted briefly above, embodiments of the enhanced scrollbar may be utilized in conjunction with categorized data groups other than data lists. As defined herein, the term “categorized data group” encompasses any compilation of information including at least two categories of data, whether the compilation of information assumes a graphical form, a textual form, or both a graphical and textual form when produced on the display system's monitor. The categorized data group may be a prioritized data list containing a number of prioritized data list sections, such as data list 34 described above in conjunction with FIGS. 2-6. Alternatively, the categorized data group may be a graphic, such as a geographical map. In such embodiments, the categorized data group may be divided into categories based on terrestrial features, such as terrain type or topography. As a first example, display system 20 (FIG. 1) may generate within viewport 32 a portion of a top-down moving map display. In this case, a first portion of the enhanced scrollbar may visually indicate that a first section of the geographical map corresponding thereto is primary comprised of mountainous terrain, and a second portion of the scrollbar may visually indicate that a second map section corresponding thereto is primary comprised of water. Thus, a user may refer to the scrollbar to quickly determine the general make-up of the geographical map (e.g., the amount of mountainous terrain relative to the amount of water) and the location of the terrain types relative to the currently-displayed portion of the map. As a second example, display system 20 (FIG. 1) may generate within viewport 32 a portion of a vertical map display wherein geographical features (e.g., areas of a mountain range) are color coded to indicate the altitude thereof. In this case, a first portion of the enhanced scrollbar may be color coded with a first color (e.g., green) to indicate that the corresponding map section contains terrain (e.g., mountain peaks) characterized by a higher altitude range, and a second portion of a first portion of the scrollbar may be color coded with a first color (e.g., brown) to indicate that the corresponding map section contains terrain characterized by a lower altitude range (e.g., the mountain's base).

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A display system for displaying a categorized data group divided into multiple data group sections by at least one section break, the display system comprising:
a monitor;
a cursor device; and
a controller operably coupled to the monitor and to the cursor device, the controller configured to generate on the monitor: (i) a viewport displaying a portion of the categorized data group, (ii) a scrollbar adjacent the viewport, and (iii) a cursor graphic positioned in accordance with user input received via the cursor device, the cursor device permitting a user to interact with the scrollbar to select which portion of the categorized data group is displayed within the viewport;
wherein the scrollbar includes a visual representation of each section break included within the categorized data group.

2. A display system according to claim 1 wherein the scrollbar comprises:
an elevator shaft; and
an elevator within the elevator shaft, the height of the elevator relative to the height of the elevator shaft generally corresponding to the length of the displayed portion of the categorized data group relative to the total length of the categorized data group.

3. A display system according to claim 2 wherein the visual representation comprises a section break graphic proximate the elevator shaft.

4. A display system according to claim 3 wherein the section break graphic comprises a line generally transecting the elevator shaft.

5. A display system according to claim 3 wherein the section break graphic visually divides the elevator shaft into multiple shaft portions, and wherein each shaft portion corresponds to, and is generally proportional with, a different data group section included within the categorized data group.

6. A display system according to claim 5 wherein the categorized data group comprises a data list, wherein the multiple data group sections comprise a plurality of prioritized data list sections, and wherein each shaft portion visually indicates the priority of the data list section corresponding thereto.

7. A display system according to claim 6 wherein each shaft portion is color coded in accordance with the priority of the data list section corresponding thereto.

8. A display system according to claim 2 wherein the width of the elevator shaft is greater than the width of the elevator, and wherein the controller is further configured to: (i) center the elevator with respect to the location of the cursor graphic when a user selects a point on the elevator shaft residing outside of the elevator's path of travel, and (ii) alter the portion of the categorized data group displayed within the viewport in accordance with the elevator's new position.

9. A display system according to claim 2 wherein the controller is further configured to generate a textbox when the cursor graphic hovers over a chosen shaft portion for a given period of time, the textbox including text indicating the content of the data group section corresponding to the chosen shaft portion.

10. A display system according to claim 6 wherein each shaft portion contains a graphical patterning indicating the priority of the data list section corresponding thereto.

11. A display system according to claim 6 wherein the display system is configured to be deployed on the flight deck of an aircraft, and wherein the data list contains text messages pertaining to the aircraft.

12. A display system according to claim 2 wherein the elevator is at least partially transparent.

13. A method for generating an enhanced scrollbar on the monitor of a display system configured to display a portion of a categorized data group within a viewport, the categorized data group containing multiple data group sections each separated by a section break, the method comprising the steps of:
determining the length of the categorized data group and the location of each section break included within the categorized data group; and
generating on the monitor: (i) an elevator shaft; (ii) an elevator within the elevator shaft, the height of the elevator relative to the height of the elevator shaft generally corresponding to the length of the displayed portion of the categorized data group relative to the total length of the categorized data group; and (iii) at least one section break graphic representative of each section break included within the categorized data group, the at least one section break graphic visually dividing the elevator shaft into multiple shaft portions each corresponding to, and generally proportional with, a different data group section included within the categorized data group.

14. A method according to claim 13 wherein the categorized data group comprises a data list including a plurality of prioritized data list sections, the method further comprising the steps of:
identifying the priority of each section included within the data list; and
modifying the appearance of the shaft portions to visually indicate the priority of data list sections corresponding thereto.

15. A method according to claim 14 wherein the step of modifying comprising color coding the shaft portions in accordance with the priority of the data list sections corresponding thereto.

16. A method according to claim 13 wherein the display system further includes a cursor device, and wherein the method further comprises the step of generating a cursor graphic positioned in accordance with user input received via the cursor device.

17. A method according to claim 16 further comprising the step of producing a text box indicating the content of a first data group section when the cursor graphic hovers over the shaft portion corresponding to the first data group section for a predetermined time period.

18. A method according to claim 16 wherein the elevator shaft has a width greater than the width of the elevator, and wherein the method further comprises the step of centering the elevator with respect to a first portion of the elevator shaft residing outside of the elevator's path of travel when a user selects the first portion of the elevator shaft utilizing the cursor device.

19. A program product for execution by an aircraft display system including a controller, at least one monitor, and a cursor device, the aircraft display system configured to display a categorized data group including multiple data group sections each separated by a section break, the program product comprising:
an avionics display program adapted to generate on the monitor:
a viewport displaying a portion of the categorized data group;
a scrollbar adjacent the viewport, the scrollbar including a visual representation of each section break included within the categorized data group; and
a cursor graphic positioned in accordance with user input received via the cursor device, the cursor device permitting a user to interact with the scrollbar to select which portion of the categorized data group is displayed within the viewport;
computer-readable media bearing the avionics display program.

20. A program product according to claim 19 wherein the categorized data group comprises a data list including a plurality of prioritized data list sections, and wherein the avionics display program is further configured to:
generate on the monitor an elevator shaft and an elevator within the elevator shaft, the height of the elevator relative to the height of the elevator shaft generally corresponding to the length of the displayed portion of the data list relative to the total length of the data list;
visually divide the elevator shaft into multiple shaft portions, and wherein each shaft portion corresponds to, and is generally proportional with, a different data list section included within the data list; and
color code the multiple shaft portions to indicate the priority of the data list sections corresponding thereto.
